(19) United States
(12) Patent Application Publication
(10) Pub. No.: US 2014/0358765 A1
(43) Pub. Date: Dec. 4, 2014

(54) Consumer Loan Borrower and Lender Customer Matching Plus Automated Decision Pricing Software

(71) Applicant: Lendsys, LLC, Simi Valley, CA (US)

(72) Inventors: Walt Agius, Simi Valley, CA (US); Grace Agius, Simi Valley, CA (US)

(73) Assignee: Lendsys, LLC, Simi Valley, CA (US)

(21) Appl. No.: 13/907,558

(22) Filed: May 31, 2013

(51) Int. Cl. G06Q 40/00

(52) U.S. Cl. CPC G06Q 40/025
USPC 705/38

(57) ABSTRACT

Disclosed is a preferred system for automated processing of loan applications. In general, the system features a database with a population of profiles of underlying lenders. Each lender profile in the database has data regarding (1) the underlying lender's consumer loan approval criteria, (2) customer lists, and (3) approved loan pricing criteria. Generally, software within the system matches electronic applications with lender according to profile data. The software determines whether any lender in the database will approve the loan application based on the lenders loan approval criteria. If the application is not approved at any point in the process, then the application is denied by the system. When an application is approved, the software within the system also prices the loan based on the pricing criteria of the approving lender.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

The subject matter of this specification is generally in the field of computer software for matching consumer loan borrowers and lenders based on customizable lender underwriting criteria.

2. Background

In modern times, consumers frequently desire to finance a variety of purchases. Consumer loan origination is the process by which a consumer (borrower) applies for a new loan and a lender processes the consumer's application. Usually, loan origination is a lengthy process because the consumer's loan application is manually processed by the lender wherein the lender reviews the application to determine whether the consumer qualifies for the loan by meeting various credit-worthiness criteria. Manual processing of an application is unsatisfactorily time-consuming. For the lender, time-consuming application review is expensive and sometimes involves reviews of obviously unworthy borrowers' applications. For the consumer, time-consuming application review is not practical for point-of-sale purchases. Manual processing of a loan application can also be problematic because the consumer must apply to multiple lenders at once so that (a) multiple loans may be compared and (b) the costs of determining credit-worthiness can be high (e.g., requesting multiple credit reports can generate excess lender fees and/or have a negative impact on a consumer's credit worthiness). In view of the foregoing, a need exists for automated processing of consumer loan applications.

Presently, various automated systems for consumer loan origination exist. For instance, Lendingtree® provides online applications for consumer loans wherein a consumer may be preapproved for a loan by multiple lenders based on various creditworthiness criteria. Although automated to a certain extent, essentially for prequalification only, once a lender is selected, the consumer must separately apply for the loan with the pre-qualifying lender in order to determine the exact loan terms. Relatedly, the lenders cannot tailor the credit-worthiness criteria employed by Lendingtree® for preapproval of the loan application so that the separate application by the preapproved borrower is necessary. Accordingly, a need remains for automated and customized processing of consumer loan applications wherein multiple lenders may processes applications according to their own criteria to produce a true and immediate loan decision at the time the application request is submitted.

In the Credit Union marketplace, a company called CU Direct offers point of sale financing. http://www.cudlretail.com/. In addition to the problems identified above in connection with Lendingtree®, CU Direct is not satisfactory for all point-of-sale purchases. For instance, CU Direct does not aggregate lenders so that a customer has a lower probability of being approved for a loan. Furthermore, CU Direct does not account for the preexisting relationships between lenders and borrowers, which relationships may result in better loan terms for the consumer. Thus, a need remains for automated processing of consumer loan applications wherein multiple lenders may processes applications according to their own criteria and that accounts for pre-existing relationships between lenders and borrowers.

### SUMMARY OF THE INVENTION

In view of the foregoing, it is an object of this disclosure to describe systems for automated processing of loan applications submitting to an aggregated base of lenders so that the system may search through the database of lenders to find a lender that wants the loan, as submitted, to secure and immediate “approved” response. In general, the system comprises: computer hardware with computer readable memory; a first database with a population profiles of underlying lenders, each of said lender profiles being defined by (1) the underlying lender's consumer loan approval criteria, (2) customer lists, and (3) approved loan pricing criteria. The system further comprises programming code on the computer readable memory, said programming code configured to have logic flow so that if any lender and the consumer have a past business relationship and the application satisfies any related lender's loan approval criteria, then the application is captured and decisioned by the lender that already has a business relationship with that consumer and approved and priced according to the related lender's pricing criteria. Otherwise, if the loan satisfies any lender's criteria then the loan is approved and priced according to the approving lender's pricing criteria. If the application does not satisfy any lender's loan approval criteria, then all of the lenders are given the opportunity to manually approve the application wherein if approved, the loan is priced according to the pricing criteria of the approving lender—and if not approved, the application is denied.

In one embodiment, the loan approval criteria in the profile of a lender may be based on the lending history of the lender, wherein loans approved by the system are incorporated into the determination of loan approval criteria applied to subsequent loan applications to the system. Similarly, the pricing criteria in the profile of a lender may be based on the pricing history of the lender for approved loans, wherein loans priced by the system are incorporated into the determination of pricing for subsequently approved loans in the system. In alternative embodiments, the lending and pricing criteria may be set by the lender or incorporate lending and pricing histories.

### BRIEF DESCRIPTION OF THE FIGURES

Other objectives of the invention will become apparent to those skilled in the art once the invention has been shown and described. The manner in which these objectives and other desirable characteristics can be obtained is explained in the following description and attached figures in which:

FIG. 1 is a logic flow diagram of an embodiment of the invention: and,

FIG. 2 is another logic flow diagram of an embodiment of the invention.

It is to be noted, however, that the appended figures illustrate only typical embodiments of the disclosed apparatus and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed is a preferred system for automated processing of loan applications. In general, the system features a database with a population of profiles of underlying lenders. Each lender profile in the database has data regarding (1) the underlying lender's consumer loan approval criteria, (2) customer lists and (3) approved loan pricing criteria. Generally, software within the system matches electronic applications with the lender according to profile data. First, the software may determine whether the applicant is a preexisting customer of a lender, and if so, it will determine whether the applicant's lender will approve the current loan application based on said lender's loan approval criteria. The software determines whether any lender in the database will approve the loan application based on the lenders' loan approval criteria. If the loan approval criteria of none of the lenders in the database is satisfied by the application, the lenders are given the opportunity to manually review and approve the application. If the application is not approved at any point in the process, then the application is denied by the system. When an application is approved, the software within the system also prices the loan based on the pricing criteria of the approving lender. Suitably, the loan approval and pricing criteria of each profile in the database may be set by the lender or incorporate lending and pricing histories.

Preferably, consumer loan approval criteria may be any data relevant to the lender for approving a loan. In one embodiment, the criteria may include: the minimum and maximum amount of money a lender will loan; the maximum amount of money a lender will loan; the minimum and maximum amount of collateral necessary for a given loan; the maximum and minimum amount of years the applicant has worked for a current employer necessary for a loan (i.e., requisite job security); the minimum and maximum FICO score necessary for approving a loan; geographic area of the loan; the number of trade-lines and period of time said trade-lines have been listed; the dollar amount of t trade-lines oases the borrower's pus capacity to handle a particular loan amount; payment history on trade-lines; any known collection or delinquent accounts and the respective dollar amounts and recency; debt-t-income, payment to income, and other related ratios that assess a consumers ability to prepay a particular loan; collateral loan vales and loan-to-value calculations; and, time at and type of residency and other criteria that asses stability. For purposes of approving a loan, the criteria may be associated with a particular weight or relevance. Those of skill in the art will know well the types data that might be incorporated into the loan approval criteria of a particular lender.

Suitably, a lender's customer list may be data identifying individuals who have received a loan from the lender. Data in the customer list may be weighted, for instance, by the recency of the calendar date of the customer and lender's last business interaction as well as current or previous payment history with said lender.

In a preferred embodiment, pricing criteria may be any data relevant to the pricing a lender will charge for the loan. The criteria may include: the duration of the loan; the number of payments; the FICO score of the approved applicant; the term and loan-to-value; the dollar amount of the loan; debt-to-income ratio; payment to income ratio; model year and milage in the case of vehicles, down payment; income level of the applicant; the number of and time-frame from which certain events (e.g., bankruptcies, foreclosures, repossession, and other related negative reported credit criteria) have taken place. For purposes of pricing a loan, the criteria may be associated with a particular weight or relevance. Those of skill in the art will know well the types data that might be incorporated into the pricing criteria of a particular lender.

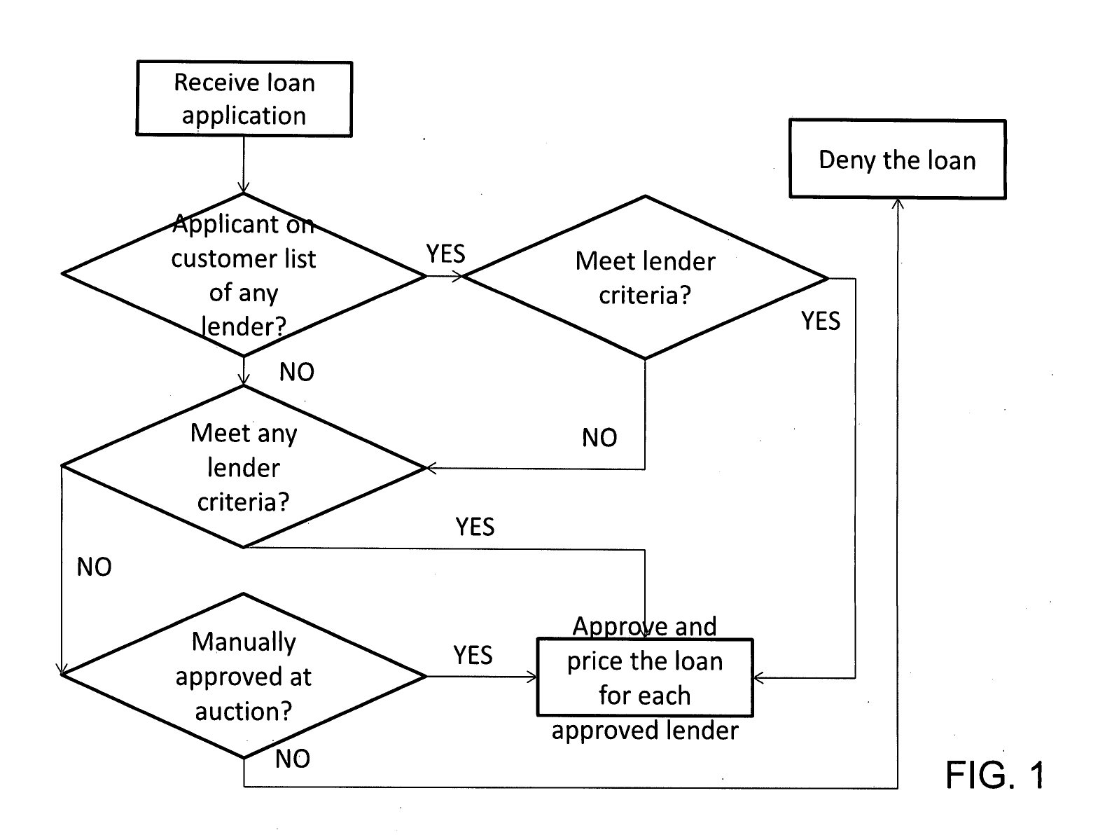

FIG. 1 is a logic flow of the software for the system. Referring to that figure, electronic loan applications may be submitted to the system. Programming code on the computer readable memory will determine whether the customer is on a customer list of a lender profile. IF the customer is on a list, THEN the loan approval criteria of the lender associated with the matched customer list is applied to the application. IF the customer is not on a customer list or IF the application does not meet the loan approval criteria of a lender that was matched in view of the customer being on the lender's customer list, THEN the system determines whether the application satisfies the loan approval criteria of any of the Lender profiles in the database. IF the application satisfies the loan approval requirements of any lender in the database, THEN the application is approved and priced according to the pricing criteria of the approving lenders in the database. Otherwise, the application is sent to auction for manual approval by any lender wherein IF the application is approved, THEN the application is approved and priced by the system according to the pricing criteria of the approving lender. IF the application does not meet the loan approval criteria of a lender and is not manually approved by a lender, then the loan application is denied.

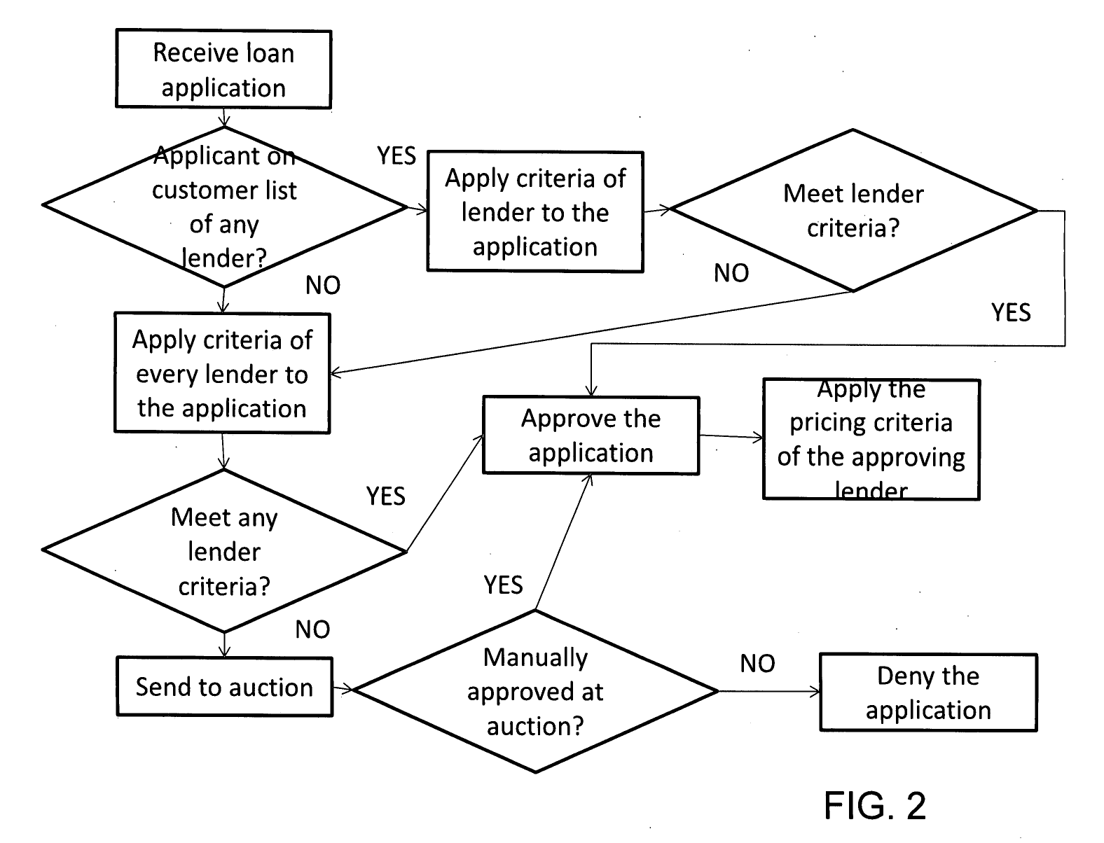

The system preferably comprises: computer hardware with computer readable memory; a first database with a population profiles of underlying lenders, each of said lender profiles being defined by (1) the underlying lender's consumer loan approval criteria, (2) customer lists, and (3) approved loan pricing criteria; and programming code on the computer readable memory, said programming code configured to:
I. review an electronic loan application of a customer and search the database of lender profiles to determine whether the customer is on a customer list of a lender profile wherein
   A. IF the customer is on a list,
   B. THEN the loan approval criteria of the lender associated with the matched customer list is applied to the application wherein
      a. IF the criteria is satisfied,
      b. THEN the loan is approved,
      c. ELSE, the loan approval criteria of each profile in the remaining population is compared, one at a time, to the application wherein
         i. IF the criteria of any profile is satisfied,
         ii. Then the customer is approved for the loan by the first-in-line lender with satisfied criteria
         iii. ELSE the application is submitted to auction wherein the lenders manually review and approve or deny the application wherein
            1. IF the application is approved for loan by any lender
            2. THEN the application is removed from auction
            3. ELSE the application is denied
   C. ELSE, the loan approval criteria of each profile in the population is compared to the application, one lender criteria at a time, wherein
      a. IF the loan approval criteria of any profile is satisfied,
      b. Then the customer is approved for the loan by the first in lender with satisfied criteria,
      c. ELSE the application is submitted to auction wherein the lenders manually review and approve or deny the application wherein
         i. IF the application is not approved for loan by any lender
         ii. THEN the application denied
         iii. ELSE the application is removed from auction and the loan approved for the lender,
II. populating the database with approved loans associated with the approving lender and applying the criterion of the approved loan to the loan approval criteria of the approving lender,
III. generate a pricing for an approved loan by applying the pricing criteria of the lender associated with the approved loan, and
IV. populate the customer list of the profile of the lender associated with the approved loan with the customer.
   The above logic flow is outlined, in detail in FIG. 2.

In one embodiment, retailers may submit a customer's loan application to the system. After submission, the application is subjected to, as described above, the loan approval and pricing criteria of all the lenders that have profiles populating the system's database. Lenders that have a business relationship with the applicant are queried and, if a relationship exists, the matched lenders' loan approval criterion is applied to the application. If the criterion is satisfied, then the loan is approved and priced. Otherwise, all the lenders' criteria are applied to the application. If no lender returns an automated approval to the retailer, then all lenders are given the opportunity to manually review the loan for approval. Suitably, the time-period for manual review can be restricted (e.g., to thirty-minutes) to avoid keeping the customer waiting. Once a lender has manually approved a loan, the loan is priced and communicated to the customer and retailer. In another embodiment the software may be incorporated into a website wherein a consumer may apply for a loan directly.

Suitably, loan approval criteria in the profile of a lender may be based on the lending history of the lender, wherein loans approved by the system are incorporated into the determination of loan approval criteria applied to subsequent loan applications to the system. Similarly, the pricing criteria in the profile of a lender may be based on the pricing history of the lender for approved loans, wherein loans priced by the system are incorporated into the determination of pricing for subsequently approved loans in the system. In alternative embodiments the lending and pricing criteria may be set by the lender or incorporate lending and pricing histories.

In a preferred embodiment, a loan approval criterion is derived by lenders and input into the system from the manual approval of past loan applications. Essentially, the criteria of formerly approved loans are interpreted as current and future approval criteria. This can result in a lender creating multiple, if not hundreds, of automated loan decision iterations (“iterations” is used as a description of the cascading effect of the individual loan decisions wherein each loan decision becomes an iteration). For example, a lender with two or more past manually decisioned loans provides the formerly approved loans to the system and the system converts the criteria for the approved loans into loan approval criteria data. Use of the historical approval data accounts for the fact that no two loan requests from different consumers are ever truly exactly the same. Even when applicants have the same credit score, for example, this can result in different approval results because the Credit Repositories determine scores differently; the applicants may not live in the same geographic area; may not have the same monetary income; may not have the same time on their current job, amount of unsecured debt, or overall debt and etceteras. Furthermore, when a loan request comes into the system, if not instantly approved according to the loan approval criteria, all lenders can manually review the application, and if approved manually, the approved criteria can then be incorporated into the loan approval criteria for that lender on all future loan requests whereby formerly manual loan approvals can be automated.

Similarly, loan pricing may depend on unique characteristics of approved loans. Preferably, the system automates pricing, based on tender-defined variables and pricing criteria. For example, an automobile loan may be approved for two consumers with the same credit score, but pricing can depend on the duration (term) of the loan, the different values of the vehicles underlying the loan requests, and/or whether collateral exists. Furthermore, if the approved loan applicants are the same, the vehicles purchased may not be, so that the lenders can have a higher loan pricing for a used vehicle than a new one. Thus, a variety of criteria can affect the both the loan approval and pricing process and may need to be considered and, can be considered by the present system.

It should be noted that this disclosure describes a preferred embodiment and is not intended to be limiting of the possible embodiments that could be used to accomplish the invented systems. Those of skill in the art may readily appreciate other useful and equally preferred embodiments of the disclosed system after reading this disclosure and such embodiments would not depart from the spirit and intent of this disclosure.

I claim:

1. A system comprising:
computer hardware with computer readable memory;
a database with a population of profiles of underlying lenders, each of said lender profiles being defined by (1) the underlying lender's consumer loan approval criteria, (2) customer lists, and (3) approved loan pricing criteria; and,
programming code on the computer readable memory configured to review the application for applying the loan approval criteria to the loan.

2. The system of claim 1 wherein the programming code is configured to review the application wherein If the customer is on a customer list of a lender profile, then the loan approval criteria of the lender is applied to the application, else the loan approval criteria of all the lender profiles are applied to the application.

3. The system of claim 2 wherein the programming code is further configured wherein if any loan approval criteria is satisfied, then the application is approved and priced according to the pricing criteria of the approving lender profile, else the application is delivered to all of the lenders for manual approval.

4. The system of claim 3 wherein if the loan is manually approved then the application is priced according to the pricing criteria of the approving lender, else the application is denied.

5. A system comprising:
computer hardware with computer readable memory;
a database with a population of profiles of underlying lenders, each of said lender profiles being defined by (1) the underlying lender's consumer loan approval criteria, (2) customer lists, and (3) approved loan pricing criteria; and
programming code on the computer readable memory, said programming code configured to review an electronic loan application of a customer and search the database of lender profiles to determine whether the customer is on a customer list of a lender profile and, if so, apply the lender's loan approval criteria to the loan.

6. A system comprising:
computer hardware with computer readable memory;
a database with a population of profiles of underlying lenders, each of said lender profiles being defined by (1) the underlying lender's consumer loan approval criteria, (2) customer lists, and (3) approved loan pricing criteria; and
programming code on the computer readable memory, said programming code configured to
I. review an electronic loan application of a customer and search the database of lender profiles to determine whether the customer is on a customer list of a lender profile wherein
A. IF the customer is on a customer list of any lender profile,
B. THEN the loan approval criteria of the lender associated with the matched customer list is applied to the application wherein
a. IF the criteria is satisfied,
b. THEN the loan is approved,
c. ELSE, the can approval criteria of each profile in the remaining population is compared to application wherein
i. IF the criteria of any profile is satisfied,
ii. Then the customer is approved for the loan by the first in line lender with satisfied criteria,
iii. ELSE the application is submitted to auction wherein the lenders manually review and approve or deny the application wherein
1. IF the application is approved for loan by any lender
2. THEN the application is removed from auction
3. ELSE the application is denied
C. ELSE, the loan approval criteria of each profile in the population is compared to the application wherein
a. IF the loan approval criteria of any profile is satisfied,
b. Then the customer is approved for the loan by the first in line lender with satisfied criteria,
c. ELSE the application is submitted to auction wherein the lenders manually review and approve or deny the application wherein
i. IF the application is not approved for loan by any lender
ii. THEN the application denied
ii. ELSE the application is removed from auction,
II. populating the database with approved loans associated with the approving lender and applying the criterion of the approved loan to the loan approval criteria of the approving lender,
III. generate a pricing for an approved loan by applying the pricing criteria of the lender associated with the approved loan, and
IV. populate the customer list of the profile of the lender associated with the approved loan with the customer.
